(19) United States
(12) Patent Application Publication
(10) Pub. No.: US 2020/0030918 A1
(43) Pub. Date: Jan. 30, 2020

(54) PROCESSING METHOD, PROCESSING SYSTEM, PROCESSING PROGRAM, AND DATA STRUCTURE

(71) Applicant: ROLAND DG CORPORATION, Hamamatsu-shi, Shizuoka (JP)

(72) Inventors: Toshio MAEDA, Hamamatsu-shi (JP); Jun UEDA, Hamamatsu-shi (JP)

(21) Appl. No.: 16/478,217

(22) PCT Filed: Jan. 17, 2018
(86) PCT No.: PCT/JP2018/001158

§ 371 Date: Jul. 16, 2019

(30) Foreign Application Priority Data
Jan. 18, 2017 (JP) 2017-006781

(51) Int. Cl. B23K 26/55; B23K 26/0622; B23K 26/384; B23K 26/53; B23K 26/00

(52) U.S. Cl. CPC B23K 26/55; B23K 26/0624; G06F 17/50; B23K 26/53; B23K 26/0006; B23K 26/384

(57) ABSTRACT

A processing method of producing a processed object by processing a material, includes forming a hollow space in the processed object by processing by ablation, the processing being performed by projecting a laser to a region in the material to be processed.

### BACKGROUND OF THE INVENTION

### 1. Field of the Invention

The present invention relates to processing methods of producing processed objects having a hollow space therein, processing systems in which the processing methods are performed, processing programs that cause the processing methods to be performed, and data structures of processing data to be used in the processing methods.

### 2. Description of the Related Art

Microfluidic devices have been widely used in biotechnological, biochemical, and chemical engineering applications. These devices have microfabricated channels and reaction chambers.

Fabrication of channels in microfluidic devices typically involves the formation of one or more grooves in the surface of a material (such as a resin or glass material) via laser radiation or etching (which are examples of micro-processing), to which another material is bonded.

JP-A-2016-148592 discloses methods of fabricating microfluidic devices in which a laser is directly projected into a glass substrate to reduce the etching resistance of that region; then the region exposed to the laser is subjected to etching to form an inner channel.

However, conventional methods of fabricating microfluidic devices are complicated because they require two or more different operations such as the formation of a groove in a material followed by bonding of another material thereto, or the laser projection followed by etching.

This problem becomes more serious with demands for increasing the number of channels in microfluidic devices or increasing the scale of microfluidic devices by, for example, forming multiple channels in a multi-layered structure or fabricating more complicated channels in terms of their shapes.

Such challenges are not restricted to microfluidic devices, it has been difficult to easily produce processed objects with a hollow space of a predetermined shape therein. Although the technique of directly projecting lasers into glass to engrave a figure or the like inside the glass (so-called 3D laser engraving) has been in use, this technique involves creating fine scratches in the glass and thus cannot form a hollow space such as a channel in microfluidic devices.

### SUMMARY OF THE INVENTION

Preferred embodiments of the present invention provide techniques to easily produce a processed object having a hollow space therein.

According to a preferred embodiment of the present invention, a processing method of producing a processed object by processing a material, includes forming a hollow space in the processed object by processing by ablation, the processing being performed by projecting a laser to one or more regions in the material to be processed.

Other features of preferred embodiments of the present invention are disclosed in the description of this specification.

According to preferred embodiments of the present invention, processed objects having a hollow space therein are able to be produced easily.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram showing a configuration of a processing system according to a preferred embodiment of the present invention.

FIG. 2 is a flow chart showing a method of producing processing data according to a preferred embodiment of the present invention.

FIG. 3A is a diagram schematically showing a processed object according to a preferred embodiment of the present invention.

FIG. 3B is a diagram schematically showing a shape data for a processed object according to a preferred embodiment of the present invention.

FIG. 3C is a diagram schematically showing a surface-of-slice data according to a preferred embodiment of the present invention.

FIG. 3D is a diagram schematically showing a divided-surface data according to a preferred embodiment of the present invention.

FIG. 4 is a flow chart showing a processing method according to a preferred embodiment of the present invention.

### DETAILED DESCRIPTION OF THE PREFERRED EMBODIMENTS

A processing method according to a present preferred embodiment is for producing processed objects having a hollow space therein by processing a material by projecting a laser. The use of lasers makes it possible to process materials in a non-contact manner.

Materials to be used are transparent to a laser (light transmitting material). Specifically, glass materials or resin materials with high light transmittance (such as acrylic resins) are used. Materials do not require 100% light transmittance and any light transmittance value will suffice as long as the laser reaches regions to be processed (described later) in the material.

The lasers used preferably are ultrashort laser pulses. Ultrashort laser pulses have a duration ranging from a few femtoseconds to a few picoseconds. By exposing one or more regions in the material to be processed to ultrashort laser pulses, processing by ablation (non-thermal processing) can be performed. Processing by ablation is a technique of melting material by irradiating it with a laser. During processing by ablation, molten material instantaneously evaporates and scatters, thereby being removed; its removal leaves a hollow space at the site that was exposed to the laser. With the processing by ablation, damage of each processed site due to heat is lower than that from using typical laser processing (thermal processing). It should be noted that processing by ablation is technically distinct from thermal processing or other techniques such as 3D laser engraving which creates fine scratches (cracks) in the material.

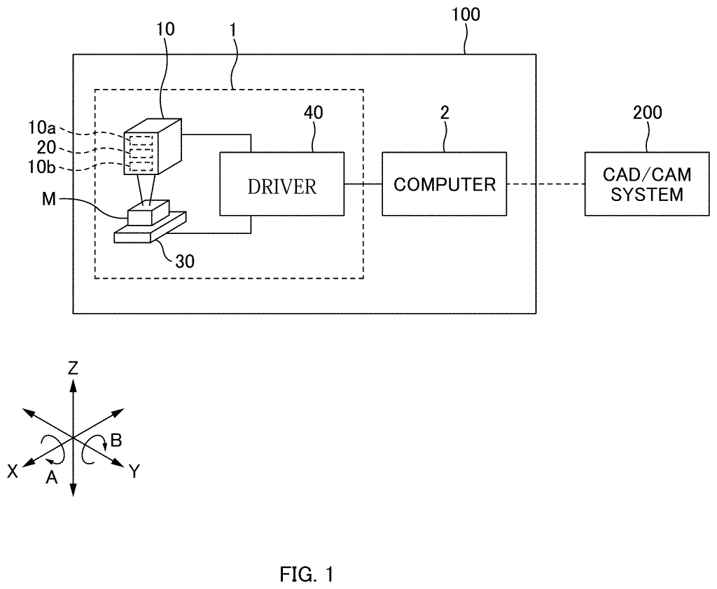

Lasers are projected into materials, which is performed based on a processing data (described later) produced in advance. In addition, the processing method according to this preferred embodiment is performed by, for example, a processing system 100 as shown in FIG. 1. The processing system 100 processes materials by executing a processing program produced by a CAD/CAM system 200. Hereinafter, “processing data,” “processing systems,” and “processing by a processing system (processing methods)” are described in detail.

Processing data are used in the processing system 100 in producing processed objects in which a hollow space is formed by processing by ablation, the processing being performed by projecting a laser to one or more regions in the material to be processed. The processing data are produced in the CAD/CAM system 200.

The processing data according to this preferred embodiment includes at least a surface-of-slice data and a region-to-be-processed data.

The surface-of-slice data is obtained by slicing a shape data for a material to a certain thickness in a certain direction. A plurality of (at least two or more) surface-of-slice data are obtained from one shape data. The slice thickness and slice direction are not particularly limited and certain conditions (thickness, direction) can be determined in advance for each CAD/CAM system 200. Alternatively, the CAD/CAM system 200 can set appropriate conditions based on, for example, the shape of a processed object, the shape of a hollow space to be formed in the processed object, and the performance (e.g., laser intensity, the type of an adjuster 20 (described later)) of the processing system 100 that uses the processing data. In addition, among conditions (thickness, direction) that are set in advance depending on the type of the material from which the processed object is formed, the type of the laser, and others, an operator may select an appropriate condition every time. The slice thickness and slice direction are preferably set such that the number of laser projections is as small as possible (such that the size of a region to be processed in each surface of a slice is as large as possible). Because the number of laser projections is as small as possible, a processing time is able to be shortened.

The region-to-be-processed data is extracted in all of the plurality of surface-of-slice data. The region-to-be-processed data is used to specify a region to which a laser is projected in a material (hereinafter, a “region to be processed”) (a data corresponding to the region to be processed). Two or more region-to-be-processed data are extracted depending on the number of the surface-of-slice data but there may be one or more surface-of-slice data containing no region-to-be-processed data depending on the shape of the region to be processed, slice thickness, slice direction, and the like.

Furthermore, one surface-of-slice data may be obtained as divided-surface data that are divided. In this case, the region-to-be-processed data is extracted for each of the divided-surface data that are divided. One surface-of-slice data can be divided into any number of divided-surface data. For example, it may be divided into a predetermined number of divided-surface data defined for each CAD/CAM system 200. Alternatively, the CAD/CAM system 200 may set an appropriate number based on, for example, the shape of the processed object or the shape of the hollow space formed inside. In addition, an operator can freely set a certain number using the CAD/CAM system 200 every time.

The processing data may include a projection pattern data. The projection pattern data is used to determine the direction of projecting a laser onto the region to be processed (details of the projection pattern are described later). As to the projection pattern data, a single data may be set for certain processing data, or different projection pattern data may be set for different surface-of-slice data, region-to-be-processed data, or divided-surface data. In addition, multiple projection patterns may be set in a region to be processed.

The processing data may include information about laser output other than projection patterns (e.g., the laser projection time and laser intensity) or information about the processing precision, information about wall treatment after processing (finishing; mirror finishing and surface modification).

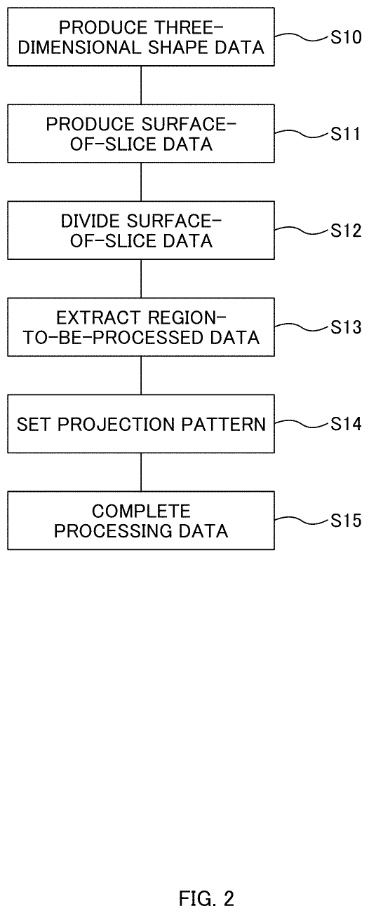

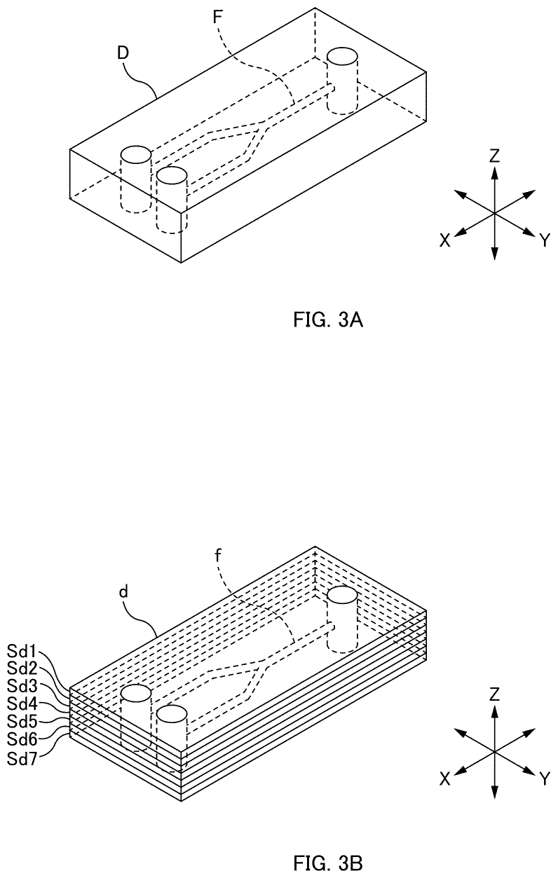

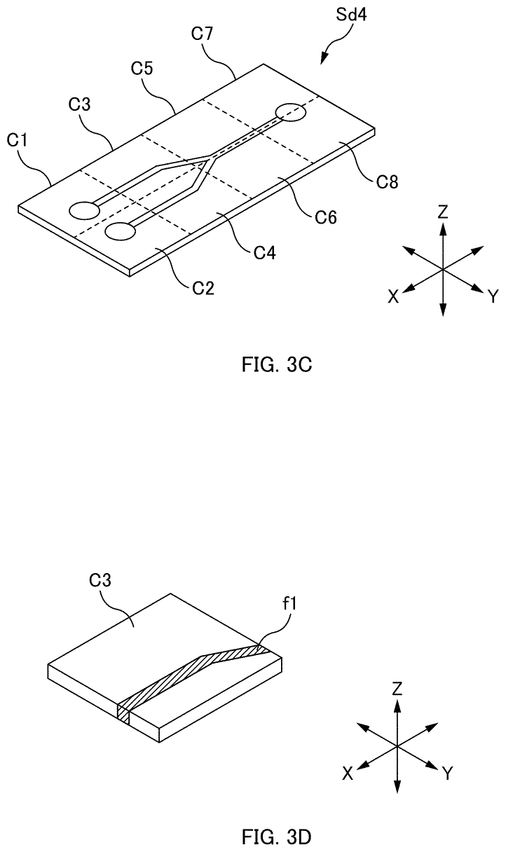

Referring to FIGS. 2 to 3D, a method of producing processing data according to this preferred embodiment is described. FIG. 2 is a flow chart showing a method of producing processing data. Here, an example of producing a processing data for processing a microfluidic device D (an example of a “processed object”; see FIG. 3A) including a bifurcated channel portion F (an example of a “hollow space”) is described. In FIG. 2 to FIG. 3D, let the lengthwise, widthwise, and height directions of the microfluidic device D (or three-dimensional shape data d) be x, y, and z-directions, respectively.

The CAD/CAM system 200 possesses, in advance, a shape data for a material from which the microfluidic device D is produced and data defining the shape of a channel portion F (x, y, and z-coordinates, shape, diameter, and others of the channel). These data may be, for example, produced in the CAD/CAM system 200 or one or more data produced in another computer may be transferred to the CAD/CAM system 200.

First, the CAD/CAM system 200 produces a three-dimensional shape data d for a microfluidic device D based on the shape data for the material and the data defining the shape of the channel portion F (a three dimensional CAD model; e.g., STL data or solid data) (produce a three-dimensional shape data; S10). The three-dimensional shape data d includes a region-to-be-processed data f corresponding to the channel portion F.

The CAD/CAM system 200 produces a plurality of surface-of-slice data obtained by slicing the three-dimensional shape data d that has been produced at S10 to a certain thickness in a certain direction (produce surface-of-slice data; S11). For example, the CAD/CAM system 200 analyzes the three-dimensional shape data d that has been produced at S10 and specifies the channel portion F (a region to be processed by a laser). Next, the CAD/CAM system 200 sets the slice thickness and slice direction based on the shape of the channel portion F (the shape of the region to be processed). Finally, the CAD/CAM system 200 can obtain a plurality of surface-of-slice data by slicing, based on the defined thickness and direction, the three-dimensional shape data d. FIG. 3B shows a state in which a plurality of surface-of-slice data Sd1 to Sd7 are formed for the three-dimensional shape data d for the microfluidic device D. These surface-of-slice data correspond to surfaces of the slice obtained by slicing the microfluidic device D along the xy-planes.

The CAD/CAM system 200 divides all of the surface-of-slice data that have been produced at S11 into a plurality of divided-surface data (divide surface-of-slice data; S12). For example, the CAD/CAM system 200 divides the surface-of-slice data Sd4 shown in FIG. 3B into a predetermined number of (for example, eight) divided-surface data C1 to C8 (see FIG. 3C).

The CAD/CAM system 200 extracts the region-to-be-processed data in all surface-of-slice data (extract the region-to-be-processed data; S13). As in S12, when one surface-of-slice data is divided into two or more divided surfaces, the CAD/CAM system 200 extracts a region to be processed for each of the divided-surface data. For example, in the example shown in FIG. 3C, the CAD/CAM system 200 extracts a region-to-be-processed data f1 for the divided-surface data C3 included in the surface-of-slice data Sd4 based on the shape data for the channel portion F (see FIG. 3D).

The CAD/CAM system 200 sets a projection pattern for a laser to be projected onto the region to be processed corresponding to the region-to-be-processed data set at S13 (set a projection pattern; S14).

By performing the above-mentioned processing, the CAD/CAM system 200 can produce a processing data including the plurality of surface-of-slice data produced at S11 (the divided-surface data divided at S12), the region-to-be-processed data extracted at S13, and the projection pattern data representing the projection pattern set at S14 (complete a processing data; step 15).

The CAD/CAM system 200 supplies the produced processing data to the processing system 100. The processing system 100 performs processing of the inside of the material by projecting a laser onto the region to be processed, based on the processing data. The output data may be in any format as long as the data can be used in the processing system 100.

The operation at S12 is not essential when, for example, the shape of the hollow space formed in the processed object is not intricate. In addition, for each processing system 100, the performance of a laser and the configuration of the adjuster 20 which are equipped are determined. Accordingly, even when the CAD/CAM system 200 sets a projection pattern, it cannot be performed in some cases. Therefore, the projection pattern may be set in the processing system 100 rather than being included in the processing data. That is, the operation at S14 is not essential as well. Furthermore, the operations at S12 and S14 may be performed after the extraction of the region-to-be-processed data (S13).

FIG. 1 is a diagram schematically showing the processing system 100. The processing system 100 produces a processed object with a hollow space therein by processing a material using a laser. The processing system 100 includes a processor 1 and a computer 2. The processing system 100, however, can include a processor 1 alone when the functions of the computer 2 are integrated into the processor 1.

The processor 1 according to this preferred embodiment has five driving axes (the x-, y-, and z-axes as well as the A-rotation axis (the rotation axis around the x-axis) and B-rotation axis (the rotation axis around the y-axis)). The processor 1 is configured or programmed to process, by ablation, a material M (inside the material M) by projecting a laser into the material M based on a processing data. The processor 1 is configured or programmed to include a projector 10, an adjuster 20, a holder 30, and a driver 40.

The projector 10 projects lasers into the material M. The projector 10 includes a laser oscillator 10a, and a group of lenses 10b to concentrate the laser light from the oscillator 10a on the material M and others. The laser oscillator 10a may be provided outside the processor 1.

The adjuster 20 adjusts laser projection patterns. The adjuster 20 may be a galvanometer mirror, a Fresnel lens, a diffractive optical element (DOE), a beam shaper to perform fragmentation processing, or a spatial light phase modulator (LCOS-SLM). The adjuster 20 is disposed, for example, between the oscillator 10a and the group of lenses 10b in the projector 10. Projection patterns that can be used by a certain processor are determined depending on the configuration of the adjuster 20 of each device.

Now, a specific example of the projection pattern is described.

For example, a pattern in which one or more lasers are projected simultaneously onto each surface of the slice (for each region to be processed included in that surface of the slice) can be achieved by using a spatial light phase modulator as the adjuster 20. Spatial light phase modulators can shape the laser produced by the oscillator 10a into a desired pattern by adjusting the liquid crystal orientation. For example, a spatial light phase modulator shapes a linear laser beam into a planar pattern and then specify a certain thickness, allowing the projection of the laser into a thin box-shape configuration (a laser with a three-dimensional shape). Using such a spatial light phase modulator, for example, processing by ablation is able to be performed by just a single laser projection onto the region to be processed corresponding to the region-to-be-processed data f1 shown in FIG. 3D. That is, by using the spatial light phase modulator, a wider region to be processed is able to be processed simultaneously, leading to reduced processing time. Furthermore, the spatial light phase modulator is able to shape laser beams into various patterns (dot, line, etc.) by adjusting the liquid crystal orientation even when the region to be processed has an intricate shape (e.g., the interface of the region to be processed has a wavy shape). Note that the adjuster 20 may not be a spatial light phase modulator as long as the above-mentioned projection patterns can be achieved. For example, a MEMS mirror can be used as the adjuster 20 to apply a laser in a planar pattern.

In addition, as the projection pattern, a pattern in which a laser is projected to a region to be processed while being scanned in a certain direction can also be used.

This can be achieved by using a galvanometer mirror as the adjuster 20. Two-axis galvanometer mirrors include two mirrors and lasers produced by the oscillator 10a can be scanned over xy-planes by driving each mirror independently. Galvanometer mirrors allow fast scanning, leading to reduced processing time.

Optical systems such as Fresnel lenses and diffractive optical elements can adjust lasers such that a laser has two or more focal points (multifocal) in a direction parallel or perpendicular to its optical axis. By using one of these optical systems as the adjuster 20, processing is able to be performed for a certain region in a direction of the width (x- and y-directions in FIG. 3D) or the thickness (z-direction in FIG. 3D) of the region to be processed by a single projection. Furthermore, by using a galvanometer mirror in combination with a Fresnel lens or a diffraction grating, it is possible to scan lasers over a wider range.

The holder 30 holds the material M. Any method can be used for holding the material M as long as the material M being held can be moved along and rotated around one of the five axes.

The driver 40 moves the projector 10 (the adjuster 20) and the holder 30 relative to each other. The driver 40 includes a servo motor to drive the projector 10, the holder 30 and other components.

The computer 2 controls operations of various structures of the processor 1. Specifically, the computer 2 controls the projector 10 and the driver 40 such that processing by ablation is performed by projecting a laser to one or more regions to be processed inside a material and a hollow space is formed, based on processing data. Furthermore, the computer 2 controls the adjuster 20 such that a laser is projected in a certain pattern for each region to be processed.

For example, the computer 2 controls the driver 40 to adjust the relative position of the projector 10 and the holder 30 (the material M held by the holder 30) such that the focal point of the laser comes to the region to be processed. Then, the computer 2 controls the projector 10 and projects the laser onto each region to be processed.

Furthermore, the computer 2 may control the projector 10 and adjust, for example, the intensity and projection time of the laser. The intensity and projection time of the laser affect the power (energy) of the projected laser. These parameters may be included in the processing data in advance as described above, or may be set by the processor 1. Furthermore, to determine these parameters, the type and properties of the material to be processed can also be taken into consideration. The computer 2 is an example of the “controller.”

The processing system 100 does not necessarily have five axes as long as a processing method described later can be performed. For example, a processor with three axes, i.e., a driving axis to drive the projector 10 in the z-direction and driving axes to drive the holder 30 in the x- and y-directions, can also be used. In addition, the adjuster 20 is not an essential component for the purpose of processing a processed object having a hollow space therein. When no adjuster 20 is provided, the laser is projected onto the region to be processed as a point because the laser from the projector 10 is directed via unifocal projection. Processing of the region to be processed with a point (a group of points) in the manner just mentioned requires a longer processing time than when using the adjuster 20, but more detailed processing can be performed. Alternatively, in the processing system 100 including the adjuster 20, it is possible to roughly process the region to be processed by projecting a laser using the adjuster 20, and then to finish it by projecting a laser without passing through the adjuster 20.

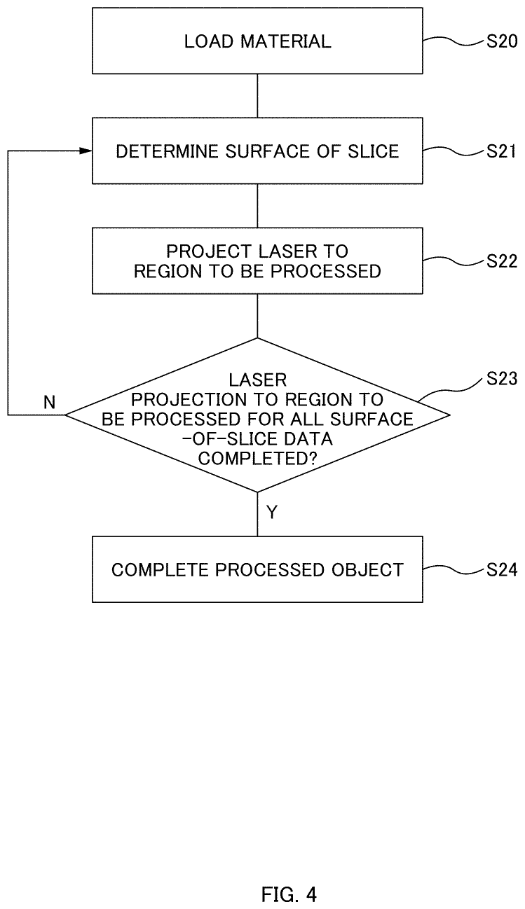

The processing method according to this preferred embodiment is a method of producing a processed object by processing a material, the processed object having a hollow space therein, the method including: forming the hollow space by processing by ablation, the processing being performed by projecting a laser to one or more regions in the material to be processed. Now, referring to FIG. 4, a specific example of the processing method according to this preferred embodiment is described.

Here, an example in which the processing method is performed in the processing system 100 is described. The processing method has been installed in advance on the processing system 100 as a dedicated processing program. In this example, as the processed object, a microfluidic device D is produced. A processing data for the microfluidic device D is produced in advance the CAD/CAM system 200.

First, a material M to be used is selected and loaded onto the holder 30 of the processor 1 (load a material; S20). The material M preferably has a shape corresponding to the shape data (outer contour) that has been used to produce the processing data. But the material M may have any shape as long as it encompasses at least the microfluidic device D.

The computer 2 causes the processor 1 to process the material M based on the processing data for the microfluidic device D.

Specifically, the computer 2 determines a surface of the slice to which a laser is projected, based on the surface-of-slice data included in the processing data (determine a surface of the slice; S21). The surface of the slice is obtained by slicing the material to a certain thickness in a certain direction.

Next, the computer 2 controls, based on the region-to-be-processed data included in the processing data, the processor 1 such that the laser is projected to a region to be processed in the surface of the slice that has been determined at S21 (project a laser to a region to be processed; S22). The region to be processed is extracted in all of the plurality of surfaces of the slice.

The computer 2 adjusts the focal position of the laser such that it comes to the region to be processed. Specifically, the computer 2 adjusts the relative position between the projector 10 and the driver 40 and adjusts the orientation and/or angle of the group of lenses included in the projector 10 as well as the state of the adjuster 20. The adjustment of the focal position etc. is preferably performed considering the refractive index of the material. After the focal position of the laser coincides with the region to be processed, the computer 2 causes the laser to be projected onto the region to be processed in a predetermined projection pattern.

The computer 2 successively determines the surface of the slice to which the laser is projected and projects the laser onto the region to be processed in each surface of the slice. That is, the laser is projected for each surface of the slice.

By projecting the laser onto the regions to be processed for all surfaces of the slice (Y at S23), the microfluidic device D having a hollow space F formed therein can be obtained (complete the processed object; S24). That is, the region to be processed corresponds to the hollow space F in the material.

It should be noted that, when the processing data includes a plurality of surface-of-slice data (see FIG. 3B), the order from which surface of the slice (or which region to be processed) the laser is projected can be set freely. For example, the laser may be projected starting from the surface of the slice corresponding to the top surface-of-slice data Sd1 or the laser may be projected randomly (e.g., the surface of the slice corresponding to the surface-of-slice data Sd3, the surface of the slice corresponding to the surface-of-slice data Sd1, . . . ).

Alternatively, as shown in FIG. 3C, when one surface-of-slice data includes a plurality of divided-surface data (one surface of the slice includes divided surfaces that are divided), the computer 2 can cause, after causing the laser to be projected successively onto the regions to be processed that are extracted in each divided surface (after causing the laser to be projected to all regions to be processed in one surface of the slice), the laser to be projected onto the region to be processed corresponding to the region-to-be-processed data that is extracted in another surface-of-slice data (the region to be processed in a surface of the slice that is different from those to which the laser has already been projected). On the other hand, the computer 2 can cause, after causing the laser to be projected to some of the regions to be processed that are extracted in each divided surface (after causing the laser to be projected to some regions to be processed in one surface of the slice), the laser to be projected onto the region to be processed that is extracted in another surface-of-slice data.

As described above, in the processing method according to this preferred embodiment, by projecting a laser to a region to be processed in a material, a hollow space can be formed by processing by ablation of the region to be processed. Therefore, it is unnecessary to perform, after the processing of the material, operations such as bonding of another material or etching, and processed objects are able to be produced easily.

Laser projection for each of the surfaces of the slice onto the region to be processed that is extracted for each of the surfaces of the slice allows detailed processing. Therefore, even in the cases in which a hollow space has an intricate shape, processed objects are able to be produced easily.

Furthermore, by dividing one surface of the slice further (producing divided surfaces) and projecting the laser for each divided surface, more detailed processing can be performed. Therefore, even in the cases in which a hollow space has an intricate shape, processed objects are able to be produced easily.

Furthermore, the use of, for example, a spatial light phase modulator, to project the laser simultaneously for each of the regions to be processed makes it possible to process a wider range by single laser projection. Therefore, processed objects are able to be produced in a short period of time.

Furthermore, with the processing system according to this preferred embodiment, the laser can be projected onto the region to be processed in the material while moving the projector and the driver relative to each other. Therefore, it is unnecessary to perform, after the processing of the material, operations such as bonding of another material or etching, and processed objects are able to be produced easily.

In addition, the computer 2 of the processing system controls the projector 10 such that the laser is projected for each surface of the slice, which makes detailed processing possible. Therefore, even in the cases in which a hollow space has an intricate shape, processed objects are able to be produced easily.

In addition, the computer 2 controls the adjuster 20 such that the laser is projected simultaneously for each of the regions to be processed, allowing processing of a wide range by single laser projection. Therefore, processed objects are able to be produced in a short period of time.

Furthermore, by executing the processing program according to this preferred embodiment in the processing system, it becomes possible to form a hollow space by processing by ablation, the processing being performed by projecting a laser to a region to be processed in a material. Therefore, it is unnecessary to perform, after the processing of the material, operations such as bonding of another material or etching, and processed objects are able to be produced easily.

Furthermore, the processing data according to this preferred embodiment includes a plurality of surface-of-slice data obtained by slicing a shape data for the material to a certain thickness in a certain direction; and region-to-be-processed data corresponding to the regions to be processed extracted in all of the plurality of surface-of-slice data. By processing materials using such processing data, processed objects having a hollow space therein are able to be produced easily.

It should be noted that, while the above-mentioned preferred embodiments have been described in terms of the examples in which the region to be processed is processed for each surface of the slice, the processing per surface of the slice is not necessarily required. For example, when the inner hollow space does not have a complicated shape as in the channel portion F of the microfluidic device D, the hollow space can be formed directly by projecting the laser onto the region to be processed in the material based on the region-to-be-processed data, rather than dividing it into surfaces of a slice.

Processed objects that can be produced using the above-mentioned processing method are not limited to microfluidic devices. The above-mentioned processing method can be used widely for producing any processed objects having a hollow space therein.

It is also possible to supply a program to a computer using a non-transitory computer readable medium with an executable program thereon, in which the processing program to perform the processing method of the above preferred embodiments is stored. Examples of the non-transitory computer readable medium include magnetic storage media (e.g. flexible disks, magnetic tapes, and hard disk drives), and CD-ROMs (read only memories).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-9. (canceled)

10. A processing method of producing a processed object by processing a material, the processed object including a hollow space therein, the method comprising:
forming the hollow space by processing by ablation; wherein
the processing includes projecting a laser to one or more regions in the material to be processed.

11. The processing method according to claim 10, wherein
the regions in the material to be processed are extracted in all surfaces of a slice obtained by slicing the material to a certain thickness in a certain direction; and
the laser is projected for each of the surfaces of the slice.

12. The processing method according to claim 11, wherein
one of the surfaces of the slice includes divided surfaces that are divided; and
the laser is projected for each region in the divided surfaces to be processed.

13. The processing method according to claim 10, wherein the laser is projected simultaneously for each of the regions to be processed.

14. A processing system with which a processed object is produced by processing a material, the processed object including a hollow space therein, the system comprising:
a projector that projects a laser;
a holder that holds the material;
a driver that moves the projector and the holder relative to each other; and
a controller that controls the projector and the driver such that the hollow space is formed by processing by ablation; wherein
the processing is performed by projecting the laser to one or more regions in the material to be processed.

15. The processing system according to claim 14, wherein
the regions in the material to be processed are extracted in all surfaces of a slice obtained by slicing the material to a certain thickness in a certain direction; and
the controller controls the projector such that the laser is projected for each of the surfaces of the slice.

16. The processing system according to claim 15, comprising:
an adjuster that adjust a projection pattern of the laser; wherein
the controller controls the adjuster such that the laser is projected simultaneously for each of the regions to be processed.
